(19) United States
(12) Patent Application Publication
(10) Pub. No.: US 2023/0130237 A1
(43) Pub. Date: Apr. 27, 2023

(54) Leash Integrated Pet Collar Device

(71) Applicant: Cedric Lister, Manvel, TX (US)

(72) Inventor: Cedric Lister, Manvel, TX (US)

(21) Appl. No.: 17/937,818

(22) Filed: Oct. 4, 2022

Related U.S. Application Data
(60) Provisional application No. 63/271,374, filed on Oct. 25, 2021.

(51) Int. Cl. A01K 27/00

(52) U.S. Cl. CPC A01K 27/004; A01K 27/001

(57) ABSTRACT

The present invention relates to a pet collar device capable of securing a leash. In one embodiment, the leash having a static portion and a retractable line portion integrally attached to the collar and is housed in a housing. A free end of the leash is accessible to a user and has a loop fastener which is releasably fastened to a hook fastener positioned on the collar. The leash is extended by pulling the retractable line from an opening of the housing to expand the length of the leash for use by a user. In another embodiment, the leash is stored in a zippered pouch, wherein the pouch is attached to the collar and includes a zippered fastener for accessing the stored leash. One end of the leash is attached to the collar and the opposite free end is accessible for pulling out the leash from the pouch.

### CROSS-REFERENCE TO RELATED APPLICATION

The present application claims priority to, and the benefit of, U.S. Provisional Application No. 63/271,374, which was filed on Oct. 25, 2021, and is incorporated herein by reference in its entirety.

### FIELD OF THE INVENTION

The present invention relates generally to the field of pet collars. More specifically, the present invention relates to a novel pet collar having an integrated leash. In different embodiments of the invention, the leash can be secured either via a retractable mechanism and hook and loop fasteners, or a zippered pocket configured to release the leash. The leash is securely stored in a housing or pouch, preventing a user from losing or misplacing the leash. The collar eliminates requirement of carrying a separate leash by a pet owner. Accordingly, the present disclosure makes specific reference thereto. Nonetheless, it is to be appreciated that aspects of the present invention are also equally applicable to other like applications, devices, and methods of manufacture.

### BACKGROUND

By way of background, walking a pet animal, such as a dog, or cat is an important aspect of pet ownership. Pet animals require periodic walking. Pet walks provide an outlet of energy and exercise for the animal. Most dogs are required to be walked at least once each day, though some dogs, particularly very active dogs, may require more. In fact, walking makes pets friendly and approachable, reduces obesity, and provides additional health benefits. Typically, a leash is used by a person to maintain control of the pet's actions, such as to prevent the pet from wondering off during a walk. A leash is also used as a training aid and prevents the dog from chasing animals, people, or bikes. In fact, leashes are regulatory/specified requirements at many places. Traditional leashes are commonly separate from collars and generally a leash is releasably attached to a collar. As a result, when the pet walk is over, the leash is detached from the collar and needs to be stored until the next walk. Pet owners are required to locate and equip both a collar and a leash each time a pet is taken outside (i.e., for a walk).

Leashes can often be misplaced, forcing a pet owner to look multiple places for a leash which may lead to the leash not being found for the walk. It would be ideal for pet owners to have a collar that can accommodate or store a leash in a convenient manner without causing any discomfort to the pet so that the leash is not misplaced and can be readily available when walking the pet at different times. People further would desire collars that not only store a leash, but maintain their aesthetic appeal and utility.

Therefore, there exists a long-felt need in the art for an improved collar capable of securing a leash. There is also a long-felt need in the art for a dog collar that can securely accommodate a leash without affecting the utility of the collar. Additionally, there is a long-felt need in the art for an improved pet collar that eliminates chances of misplacing or losing a leash. Moreover, there is a long-felt need in the art for a pet collar that allows a pet owner to readily access a leash for a pet walking. Further, there is a long-felt need in the art for a dog collar that keeps both the collar and leash in a static location. Furthermore, there is a long-felt need in the art for a pet collar that does not allow the stored leash to be visible when the leash is not used for pet walking. Finally, there is a long-felt need in the art for a pet collar that eliminates the inconvenience of not being able to find a leash when taking pets on walks at different times.

The subject matter disclosed and claimed herein, in one embodiment thereof, comprises a pet collar having an integrated leash. The pet collar eliminates the requirement of carrying a separate leash and securely stores the leash when not used without affecting the utility of the collar. The collar has a latch for securing the collar around the neck of a pet, a length adjusting loop for adjusting length of the collar, a hollow housing attached to the front surface of the collar, a spring loaded static retracting line positioned inside the housing and attached to the collar, a leash rolled around the retracting line with a free end of the leash extending out from a hole disposed in a front surface of the housing, a hook strap positioned on the collar, the free end of the leash having a loop fastener sized to match the hook strap such that the hook fastener and the loop fastener are releasably fastened to each other for securing the leash. For using the leash, the free end of the leash is released from the hook strap and is pulled away from the housing for expanding a length of the leash by unrolling the retracting line. In another embodiment, the leash is stored in a zippered pouch with one end of the leash is integrally attached to the collar and the opposite free end is used for expanding length of the leash.

In this manner, the combined leash and collar device of the present invention accomplishes all of the forgoing objectives and provides users with an improved collar capable of securing a retractable leash. The collar device keeps both the collar and leash in a static location preventing the leash from becoming lost or misplaced, thereby improving efficiency when maintaining a daily routine for pets. The leash can be attached either through a retractable mechanism or stored in a zippered pocket.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pet collar having an integrated leash. The collar has a latch at mating ends of the collar thereof for securing the collar around the neck of a pet, a length adjusting loop for adjusting a length of the collar, a hollow housing attached to the front surface of the collar, a spring loaded retracting line positioned inside the housing and attached to the collar, a leash rolled around the retracting line with a free end of the leash extending out from a hole disposed in a front surface of the housing, a hook strap positioned on the collar, the free end of the leash having a loop fastener such that the hook fastener and the loop fastener are releasably fastened to each other for securing the leash. In use, for controlling a pet wearing the collar, the free end of the leash is released from the hook strap and is pulled away from the housing for expanding the length of the leash by unrolling the retracting line.

In yet another embodiment, a pet collar device having an integrated zippered pouch for storing a leash is disclosed. The pet collar device features a length adjuster for adjusting a length of the collar, a zipper pouch slidably attached to the collar, the pouch having a zippered fastener on a front surface thereof, a leash having a first end attached to the collar and an opposite free end stored inside the pouch, wherein the free end of the leash is pulled from the fastener for extending the stored leash for use for walking a pet. When the leash is not used, the leash is stored in the zippered pouch and is secured by fastening the zippered fastener.

In yet another embodiment, a leash integrally attached to a pet collar device is disclosed. The leash having a free end and an opposite end integrally attached to the collar, the leash is configured to be stored in a housing having a retractable line (i.e., reeled line) or in a zippered pouch when the leash is not being used by a pet owner.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a pet collar with integrated retractable leash device of the present invention in accordance with the disclosed architecture;

FIG. 2 illustrates a perspective view showing the process of using the retractable leash integrated collar device of FIG. 1 in accordance with the disclosed architecture;

FIG. 3 illustrates a perspective view showing the collar device of FIG. 1 being used by a pet owner for walking a dog in accordance with the disclosed architecture;

FIG. 4 illustrates a perspective view of another embodiment of the leash attached collar device of the present invention in accordance with the disclosed architecture; and

FIG. 5 illustrates a perspective view showing access of the integrated leash from the zipper pouch of collar device of FIG. 4 in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved collar capable of securing a leash. There is also a long-felt need in the art for a dog collar that can securely accommodate a leash without affecting the utility of the collar. Additionally, there is a long-felt need in the art for an improved pet collar that eliminates chances of misplacing or losing a leash. Moreover, there is a long-felt need in the art for a pet collar that allows a pet owner to readily access a leash for walking a pet. Further, there is a long-felt need in the art for a pet collar that keeps both the collar and leash in a static location. Furthermore, there is a long-felt need in the art for a pet collar that does not allow the stored leash to be visible when the leash is not being used for pet walking. Finally, there is a long-felt need in the art for a pet collar that eliminates the inconvenience of not being able to find a leash when taking pets on walks at different times.

The present invention, in one exemplary embodiment, is a pet collar device having an integrated zippered pouch for storing a leash. The pet collar device features a length adjuster for adjusting a length of the collar, a zipper pouch slidably attached to the collar, the pouch having a zippered fastener on a front surface thereof, a leash having a first end attached to the collar and an opposite free end stored inside the pouch, wherein the free end of the leash is pulled from the fastener for extending the stored leash for use for walking a pet. When the leash is not used, the leash is stored in the zippered pouch and is secured by fastening the zippered fastener. In other embodiments, a retractable or reeled line is used for storing the leash within a housing attached to the collar.

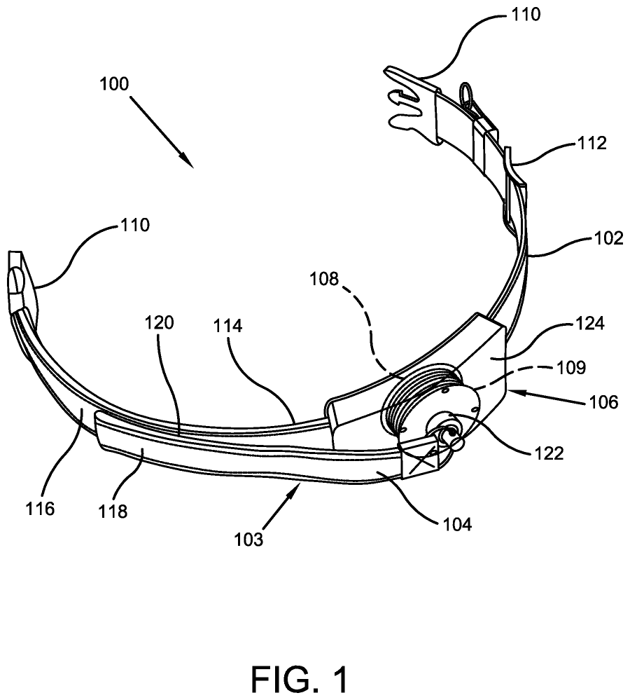

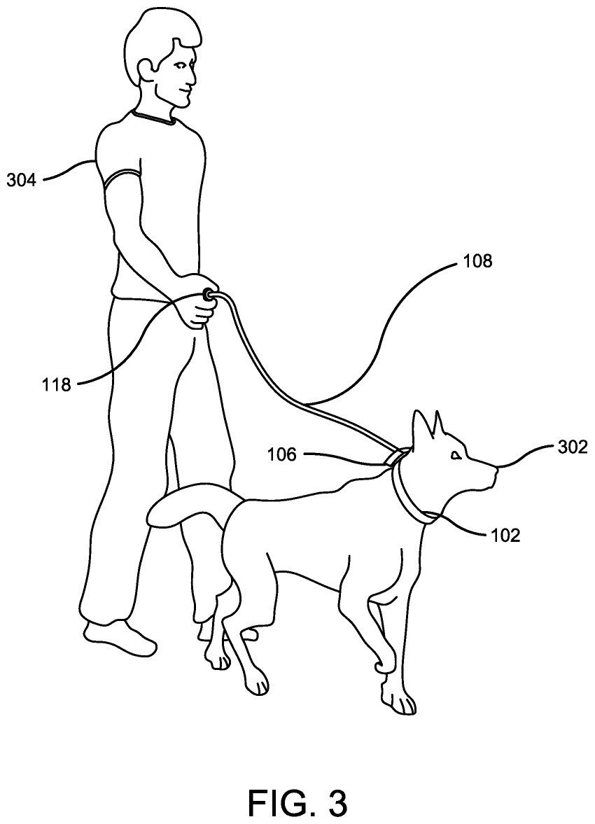

Referring initially to the drawings, FIG. 1 illustrates a perspective view of one potential embodiment of a pet collar with integrated retractable leash device of the present invention in accordance with the disclosed architecture. The pet collar device 100 of the present embodiment is designed as an improved collar 102 having a leash 103 including an unretractable leash portion 104 and a retractable leash portion 108 concealed in a housing 106. The housing 106 overlaps a portion of the collar 102 and is attached to the collar 102, further, the housing 106 includes the retractable leash portion or reeled line 108 for accommodating the leash 104. The retractable leash portion 108 can comprise a cable or nylon line. The collar 102 has a latch 110 for securing the device 100 around the neck of a pet such as a dog as illustrated in FIG. 3 and has a length adjuster loop 112 for enabling the length of the collar 102 to adjust as per preferences of a pet owner. The retractable leash portion or reeled line 108 includes a spring-loaded reel 109 and is integrally attached to the collar 102 thereby providing a static position of the leash 104. The leash 103 extends out of the housing 106 via an opening 122 positioned at the center of the front surface 124 of the housing 106.

A hook fastener 114 is disposed on the front surface 116 of the collar 102, preferably extending from one end of the housing 106 to overlap a portion of the collar 102. The hook fastener 114 can be sewn or attached using an adhesive on the front surface 116 such that the free end 118 of the retractable leash 103 having a loop fastener 120 is releasably fastened to the hook fastener 114. The loop fastener 120 of the leash 103 is fastened to the hook fastener 114 when the leash 103 is in a retracted position and the retractable portion 108 of the leash 103 is housed inside the housing 106, thereby preventing the free end 118 of the unretractable portion 104 from becoming torn or bitten by the pet wearing the collar device 100. The free end 118 of the unretractable portion of the leash 104 has a loop that can additionally include padding or cushioning thereon to provide the pet owner with a comfortable grip.

For accessing the leash 103 by a user such as a pet owner, the loop fastener 120 is detached from the hook fastener 114 and the unretractable portion 104 is pulled away from the housing 106 enabling the retractable portion (i.e. line) 108 to unwind/unreel and release a desired length of the leash 103.

Both the collar 102 and the leash 103 are preferably made of a durable fabric material such as nylon or leather, a composite material, or other materials conventionally used to manufacture pet leashes and collars. The housing 106 can be flexible and can be made from nylon, fabric, or durable plastic. The housing 106 hides the retractable portion or line 108 and the leash stored therein, thus, the housing 106 helps in maintaining the aesthetic appeal and comfort of the collar 102. In one embodiment, the housing 106 can be coated with a reflective material for reflecting light falling on it, thus, enabling the housing 106 to illuminate in dark or low light areas.

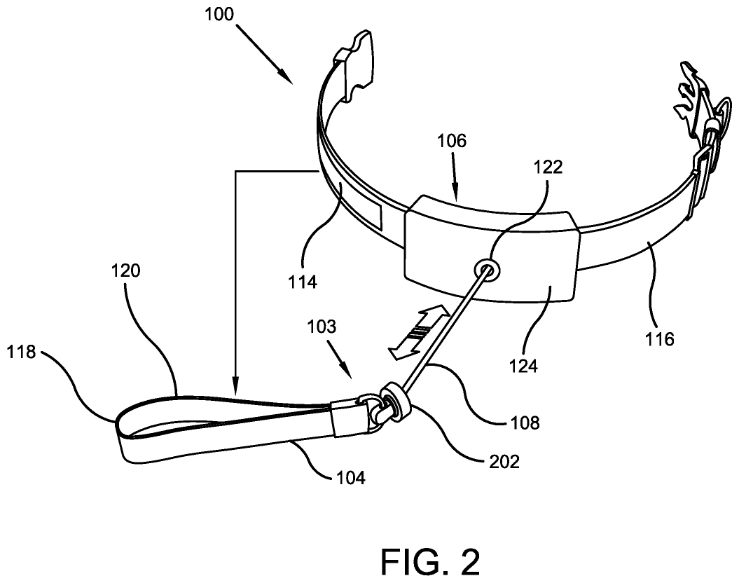

FIG. 2 illustrates a perspective view showing the process of using the retractable leash 103 integrated collar device of FIG. 1 in accordance with the disclosed architecture. For using the collar device 100 of FIG. 1 for safely walking a pet without searching for a leash, the loop fastener 120 of the leash 103 is unfastened from the hook fastener 114 to release the free end 118 of the leash 103. The free end or loop 118 is then pulled away from the housing 106 causing the leash 103 to unwind the retractable portion 108 positioned inside the housing 106. When the leash 103 is pulled by a user holding the free end 118, the retractable portion 108 is released and extends/unwinds out from the opening 122. The leash connector 202 abuts against the front surface 124 of the housing 106 when the leash 103 is retracted such as when the leash 103 is not used thereby enabling the front end 118 of the unretractable portion 104 of the leash 103 to remain accessible to a user.

It should be appreciated that the free end 118 of the leash 103 is wider and includes padding for a comfortable grip whereas the length of the leash 108 extending from the connector 202 comprises a thin line or wire that can pass through the opening 122. In some embodiments, the front surface 124 of the housing 106 is removable thereby enabling a user to troubleshoot or replace the retracting line 108 when required.

FIG. 3 illustrates a perspective view showing the collar device 100 of FIG. 1 being used by a pet owner for walking a dog in accordance with the disclosed architecture. As illustrated, the collar 102 is wrapped around the neck of a dog 302 like a conventional dog collar and a pet owner 304 holds the free end 118 of the leash 103 and extends/unwinds a desired length of the retractable portion 108 of the leash 103 from the housing 106 attached to the collar 102. The retractable portion 108 of the leash 103 being housed in the housing 106 eliminates the requirement of carrying a separate leash by the pet owner 304. In the preferred embodiment, the length of the leash 103 can expand up to six feet enabling the pet owner 304 to easily control and manage the dog 302 attached thereto.

When the leash 103 is not to be used such as after a pet walk, the retractable portion 108 of the leash 103 can be retracted back to the reeled line positioned inside the housing 106. It should be noted that housing 106 and the leash portion 108 stored therein, does not touch the skin of the dog 302; and further, the leash 103 is lightweight and therefore does not provide any discomfort to the dog 302.

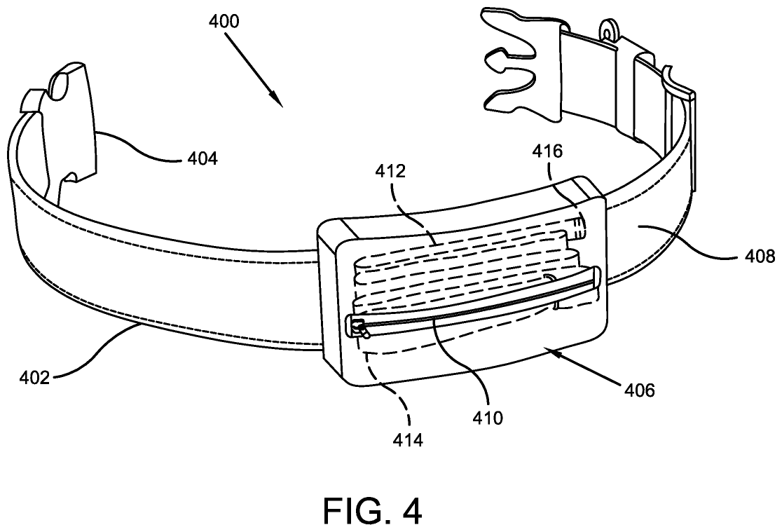

FIG. 4 illustrates a perspective view of another embodiment of the leash attached collar device of the present invention in accordance with the disclosed architecture. In the present embodiment, the collar device 400 has a collar 402 having a latch means 404 such as a buckle for fastening the collar 402 around the neck of a pet. A zipper pouch 406 is sewn on the front portion 408 of the collar 402, preferably at the lengthwise central point of the collar 402. The zipper pouch 406 has a zipper fastener 410 configured to unfasten the pouch 406 for accessing a leash 412 stored therein. The leash 412 is securely attached to the front surface 408 of the collar 402 and enclosed by the pouch 406 such that the when the leash 412 is not used, the leash 412 remains securely placed in the pouch 406.

The pouch/pocket 406 is preferably made of fabric, denim cloth, plastic, or any other similar material. In some embodiments, the pouch 406 can slide along the length of the collar 402, enabling a user to adjust the position of the pocket 406 as per preference of a pet wearing the collar device 400. All other manufacturing specifications of the device 400 can be same as of the collar device 100 of other embodiments of the present invention.

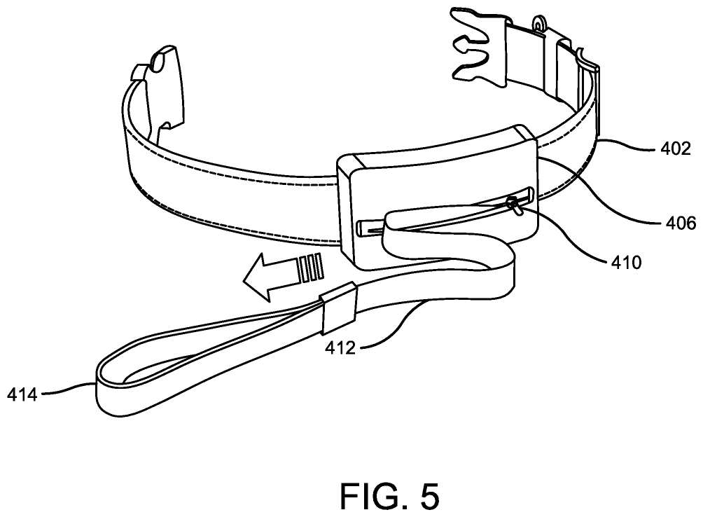

FIG. 5 illustrates a perspective view showing access of the integrated leash from the zipper pouch of collar device of FIG. 4 in accordance with the disclosed architecture. For accessing the leash 412 for use by a user such as a pet owner, the zipper 410 is unfastened and the free end or handle 414 of the leash 412 is pulled to access the leash 412. One end of the leash 416 (shown in FIG. 4) is integrally attached to the collar 402 thereby making a secure connection of the collar 402 and the leash 412. After use of the leash 412, the leash 412 can be rolled/folded and stored in the pouch 406 and secured by fastening the zipper 410. The leash 412 can have a length from about three feet to about six feet and can be made from nylon or leather. The leash 412 can comprise a nylon strap.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “pet collar with integrated retractable leash device”, “collar device”, “leash attached collar device”, “retractable leash integrated collar device”, and “device” are interchangeable and refer to the leash integrated pet collar device 100,400 of the present invention.

Notwithstanding the forgoing, the leash integrated pet collar device 100, 400 of the present invention can be of any suitable size and configuration as is known in the art without affecting the overall concept of the invention, provided that it accomplishes the above-stated objectives. One of ordinary skill in the art will appreciate that the leash integrated pet collar device 100, 400 as shown in the FIGS. are for illustrative purposes only, and that many other sizes and shapes of the leash integrated pet collar device 100, 400 are well within the scope of the present disclosure. Although the dimensions of the leash integrated pet collar device 100, 400 are important design parameters for user convenience, the leash integrated pet collar device 100, 400 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pet collar with integrated retractable leash device comprising:
a pet collar having a pet leash and a housing attached thereto;
wherein said pet leash having an unretractable portion and a retractable portion;
wherein said retractable portion windable around a reel in said housing; and
further wherein said housing overlaps a portion of said pet collar.

2. The pet collar with integrated retractable leash device of claim 1, wherein said reel is integrally attached to said pet collar.

3. The pet collar with integrated retractable leash device of claim 2, wherein said reel is spring loaded.

4. The pet collar with integrated retractable leash device of claim 3, wherein said pet collar comprises a latch and a length adjuster loop for adjusting a length of said pet collar.

5. The pet collar with integrated retractable leash device of claim 1, wherein said unretractable portion comprises a static length extending out from said housing.

6. The pet collar with integrated retractable leash device of claim 5, wherein said unretractable portion comprises a loop handle.

7. The pet collar with integrated retractable leash device of claim 6, wherein said pet collar comprises a hook fastener disposed on a front surface of said pet collar.

8. The pet collar with integrated retractable leash device of claim 7, wherein said loop handle comprises a loop fastener for releasably fastening to said hook fastener.

9. The pet collar with integrated retractable leash device of claim 1, wherein said retractable portion is a cable.

10. The pet collar with integrated retractable leash device of claim 1, wherein said retractable portion is a nylon line.

11. A pet collar with integrated retractable leash device comprising:
a pet collar having a pet leash and a housing attached thereto;
wherein said pet leash foldable inside said housing;
wherein said housing having a fastener for selectively opening and closing said housing to retain said pet leash; and
further wherein said housing overlaps a portion of said pet collar.

12. The pet collar with integrated retractable leash device of claim 11, wherein said fastener is a zipper.

13. The pet collar with integrated retractable leash device of claim 11, wherein said pet collar having a latch and a length adjuster loop for adjusting the length of said pet collar.

14. The pet collar with integrated retractable leash device of claim 11, wherein said pet leash comprises a free end handle.

15. The pet collar with integrated retractable leash device of claim 14, wherein said free end handle is a loop handle.

16. The pet collar with integrated retractable leash device of claim 15, wherein said pet leash is a nylon strap.

17. A pet collar with integrated retractable leash device comprising:
a pet collar having a pet leash and a housing attached thereto;
wherein said pet leash having an unretractable portion and a retractable portion;
wherein said retractable portion windable around a reel in said housing;
wherein said housing overlaps a portion of said pet collar;
wherein said reel is spring loaded; and
wherein said unretractable portion having a loop handle.

18. The pet collar with integrated retractable leash device of claim 17, wherein said unretractable portion having a static length extending out from said housing.

19. The pet collar with integrated retractable leash device of claim 18, wherein said pet collar comprises a hook fastener disposed on a front surface of said pet collar.

20. The pet collar with integrated retractable leash device of claim 19, wherein said loop handle comprises a loop fastener for releasably fastening to said hook fastener.
